(19) United States
(12) Patent Application Publication
(10) Pub. No.: US 2024/0060353 A1
(43) Pub. Date: Feb. 22, 2024

(54) OPENING DEVICE FOR DISPLACING A VEHICLE DOOR

(71) Applicants: Brose Fahrzeugteile SE & Co. Kommanditgesellschaft, Bamberg, Bamberg (DE); BODE - DIE TÜR GMBH, Kassel (DE)

(72) Inventors: Harald HUGEL, Bamberg (DE); Christian GITTER, Zeil am Main (DE); Daniel MUSCHEL, Würzburg (DE)

(21) Appl. No.: 18/256,017

(22) PCT Filed: Nov. 10, 2021
(86) PCT No.: PCT/EP2021/081183

§ 371 Date: Jun. 5, 2023

(30) Foreign Application Priority Data
Dec. 7, 2020 (DE) 10 2020 215 439.2

(51) Int. Cl. E05F 15/646

(52) U.S. Cl. CPC E05F 15/646; E05Y 2800/122; E05Y 2900/531; E05Y 2201/626

(57) ABSTRACT

It is provided an opening device for displacing a vehicle door, comprising a support member for fastening the opening device to a vehicle, a telescopic device, comprising a rotational member which is hinged to the support member by an end portion, and a pull-out member which is mounted on the rotational member such that it can be displaced along a pull-out direction with respect to the rotational member. In addition, the opening device comprises at least one connecting portion arranged on the pull-out member for connecting the telescopic device to the vehicle door of the vehicle, and a lever which is rotatably coupled to the support member by a first end portion and rotatably coupled to the pull-out member by a second end portion in order to the vehicle door connected to the telescopic device by pivoting of the lever.

### BACKGROUND

The proposed solution relates to an opening device which can be fastened to a vehicle, can be connected to a vehicle door of the vehicle and is configured to displace the vehicle door at least partially along a longitudinal extension axis of the vehicle in order to release or close an opening of the vehicle.

Opening devices that are configured to displace vehicle doors proportionally along a longitudinal extension axis of a vehicle are known in particular from the field of public transport in connection with sliding doors. A vehicle door with such an opening device must be displaced by a displacement movement with two movement components. By means of a first movement component, the vehicle door is lifted from a position in which it is flush with the vehicle outer skin. By means of a second movement component, the lifted vehicle door must be displaced relative to an opening in the vehicle outer skin in order to release the opening for use.

Displacement movements with two movement components can be realized, for example, using a plurality of separate drives or electronic switching between several gear stages with different directions of action.

The connection of additional drives or gear stages takes up additional installation space and increases material-related costs. In addition, sequential timing of the displacement movement may necessitate an electronic control device with associated sensors. This entails additional costs as well. Finally, the probability of failure of the opening device is also increased by the connection of several drives and their interfaces in the control sequence.

Furthermore, especially for a possible application in public transport, the opening to be released by a vehicle door via an opening device should be large enough to allow several vehicle users to get in and/or out at the same time. In particular, there is thus a need to be able to displace the vehicle door as far as possible in the direction of the longitudinal extension axis of the vehicle. The further the vehicle door is displaced in the direction of the longitudinal extension axis of the vehicle, the greater the distance between a force acting on the door and a connection between the door and a vehicle body can be. In this case, in particular vertically acting forces, such as a weight force of the door or persons holding onto the door, can load the connection of the door to the vehicle body with high torques. Rail guides may therefore be necessary to sufficiently stiffen the connection between the vehicle door and the vehicle body against vertical forces, even in the open state.

At the same time, the additional rail guide also increases the installation space, weight and assembly effort, which ultimately translates into increased manufacturing and operating costs.

### SUMMARY

The proposed solution is therefore based on the object of overcoming or at least reducing the aforementioned disadvantages.

This object is achieved by means of an opening device having features as described herein.

Accordingly, the proposed opening device comprises, inter alia, a support member which is adapted to be attached to a vehicle. Furthermore, the opening device comprises a telescopic device, which in turn comprises a rotational member and a pull-out member. In this case, the rotational member is hinged with an end portion to the support member, and the pull-out member is mounted on the rotational member such that it can be displaced along a pull-out direction with respect to the rotational member. At least one connecting portion is arranged on the pull-out member for connecting the telescopic device to a vehicle door. In addition, the proposed opening device comprises a lever which is rotatably coupled to the support member by a first end portion and rotatably coupled to the pull-out member by a second end portion in order to displace the vehicle door connected to the telescopic device by pivoting the lever.

Here, pivoting the lever causes a displacement movement of the vehicle door connected to the telescopic device with at least two differently directed movement components. The vehicle door is displaced with a first movement component via a pivotal connection of the rotational member to the support member. Via a displacement of the pull-out member along the pull-out direction, the vehicle door is displaced with a second movement component. Thus, the opening device is basically configured to lift the vehicle door out of an opening in a vehicle outer skin via the first movement component by pivoting the lever, and to displace it relative to the opening via the second movement component, in order to release the opening for use.

The pivoting of the lever can thus be translated into a multi-component displacement movement of the vehicle door without control electronics or switching devices. In particular, this allows the vehicle door to be displaced by means of external force using only one motorized drive for the lever. In principle, further drives are not necessary. The restriction to a single drive can reduce installation and maintenance costs as well as the space required for the opening device.

To realize a multi-component displacement movement, in one embodiment the rotational member can be coupled to the support member via a thrust joint so as to be displaceable along a displacement direction of the thrust joint. In this case, a movement of the rotational member by the thrust joint can be restricted to a displacement along the displacement direction. In this case, the displacement direction of the thrust joint and the pull-out direction can basically be configured differently. In particular, the displacement direction of the thrust joint can be oriented transversely to a longitudinal extension axis of the vehicle and the pull-out direction can be oriented parallel to the longitudinal extension axis of the vehicle when the opening device is mounted on the vehicle as intended. In this context, the pull-out member can also be displaceable along the displacement direction of the thrust joint via a bearing on the rotational member. Consequently, the at least one connecting portion arranged on the pull-out member can also be displaceable along the displacement direction of the thrust joint.

In an alternative or complementary embodiment, the rotational member can be rotatably hinged to the support member to implement a multi-component displacement movement. Thus, the pivotal connection to the support member can limit the rotational member to a pivoting movement about the pivotal connection to the support member. Similarly, the pull-out member can be pivotable about the pivotal connection of the rotational member with the support member via the bearing on the rotational member. Consequently, this may also apply to the at least one connecting portion arranged on the pull-out member. The at least one connecting portion can describe a circular arc-shaped displacement path when pivoting about the pivotal connection of the rotational member to the support member.

In an alternative embodiment, the pivotal connection from the rotational member to the support member can also be configured as a rotary thrust joint.

In order to be able to translationally displace the vehicle door connected to the opening device along a direction, the rotational member and the pull-out member are basically displaceable relative to each other along the pull-out direction. Thus, a longitudinal extension of the telescopic device in the direction of the longitudinal extension axis of the rotational member can be displaceable between a minimum extension and a maximum extension. By displacing the pull-out member along the pull-out direction, the at least one connecting portion can be displaceable between a closure position and an open position. In this case, a center of the connecting portion in the closure position has a first distance relative to an end portion of the rotational member on the side of the support member and, in the open position, has a second distance relative to the end portion of the rotational member. In particular, the first distance can be smaller than the second distance.

Furthermore, the at least one connecting portion can in principle also be displaceable by means of a superposition of the displacement movement specified by the pivotal connection of the rotational member to the support member and the translational displacement along the pull-out direction.

The lever is restricted by a pivotal connection with the support member to pivoting movement about the pivotal connection with the support member. Since the second end portion of the lever is pivotally connected to the pull-out member, the aforementioned superimposed movement of the at least one connecting portion is enforceable by pivoting the lever. In the following, the superimposed movement of the at least one connecting portion is referred to as the displacement movement of the at least one connecting portion. Thus, by pivoting the lever, the at least one connecting portion is displaceable along a displacement path between the closure position and the open position.

As a result of the connection of the telescopic device to the vehicle door, the vehicle door can also be displaced along the displacement path of the at least one connecting portion by pivoting the lever. Depending on a pivoting direction of the lever, it may thereby also be possible to displace from an open position of the vehicle door to a closure position of the vehicle door. Consequently, an opening device of the proposed solution can be configured to displace the vehicle door along the displacement path of the connecting portion from the closure position to the open position of the vehicle door by pivoting the lever in an opening direction. Furthermore, the opening device can be configured to displace the vehicle door along the displacement path of the connecting portion from the open position to the closure position of the vehicle door by pivoting the lever in a closing direction. In particular, the opening device can be arranged on the vehicle such that the vehicle door connected to the opening device closes an opening in the vehicle outer skin in the closure position. In the closure position, the vehicle door can be flush with the vehicle outer skin. In addition, the opening device can be arranged on the vehicle in such a way that the vehicle door connected to the opening device releases the opening in the vehicle outer skin in the open position.

Furthermore, the use of the proposed opening device eliminates the need for an additional rail guide for the vehicle door. This can save both installation space and material costs.

In general, a longitudinal extension axis of the pull-out member can be arranged parallel with respect to the longitudinal extension axis of the rotational member. To increase the translational portion in the aforementioned superimposed displacement movement of the at least one connecting portion, the telescopic device can further comprise a further pull-out member. In this case, the further pull-out member can be mounted on the pull-out member so as to be displaceable along the pull-out direction relative to the pull-out member. Consequently, a longitudinal extension axis of the further pull-out member can also be arranged in each case parallel with respect to the longitudinal extension axes of the rotational member and of the pull-out member.

In the embodiment of the opening device with two pull-out members, the maximum extension of the telescopic device can be increased while the minimum extension remains the same compared to the embodiment with one pull-out member. Alternatively, the use of two pull-out members can reduce the minimum extension of the telescopic device while maintaining the same maximum extension. This can reduce the installation space of the opening device. In particular, a full extension of the telescopic device can be realized.

In order to also increase the translational portion in the aforementioned superimposed displacement movement of the vehicle door connected to the opening device, the at least one connecting portion can be arranged on the further pull-out member. Consequently, the vehicle door can be connected to the telescopic device via the further pull-out member. The opening device in an embodiment with two pull-out members can thus be configured to displace the vehicle door further along the pull-out direction in terms of amount than an opening device in an embodiment with exactly one pull-out member.

In particular, this can allow simultaneous entry and exit of a plurality of vehicle users.

In exemplary embodiments, the rotational member, the pull-out member and the further pull-out member can be configured as hollow rods of different diameters. In this case, the hollow rods can be configured with respect to an outer and inner diameter in such a way that the outer diameters of two of the hollow rods are each less than or equal to at least one inner diameter of the remaining two hollow rods. This allows the hollow rods to be pushed into one another.

In an alternative embodiment, the bearing of the pull-out member on the rotational member and of the further pull-out member on the pull-out member can be configured as a rail guide. The configuration of the bearings as a rail guide can here reduce the installation space of the telescopic device and friction losses. In addition, a rail guide can further stiffen the telescopic device and thus the opening device against forces acting vertically on the vehicle door.

In principle, the telescopic device can be configured in such a way that a displacement of the pull-out member relative to the rotational member along the pull-out direction also causes a displacement of the further pull-out member relative to the pull-out member along the pull-out direction. For this purpose, the rotational member can be operatively connected to the further pull-out member via a coupling member. Accordingly, the telescopic device can be configured to transmit a force acting on the pull-out member in the direction of the pull-out direction to the further pull-out member. In principle, a reversal of the direction of force transmission is also possible. Thus, the telescopic device can also be configured to transmit a force acting on the pull-out member counter to the direction of the pull-out direction to the further pull-out member. Consequently, the two pull-out members can be displaced in a coupled manner along the pull-out direction by transmitting a force to the pull-out member.

In a supplementary embodiment, the lever can be hinged to the pull-out member by the second end portion. As a result, by pivoting the lever, the pull-out member and the further pull-out member can be displaced in a coupled manner along the pull-out direction.

In one embodiment of the proposed opening device, the coupling member can be formed with a chain or a band. In particular, the chain or the band can be arranged in a circumferential manner on the pull-out member. Furthermore, the coupling member can be connected to both the pull-out member and the further pull-out member for transmitting a force acting on the pull-out member to the further pull-out member.

In the event of a force acting on the pull-out member along the pull-out direction, the coupling member connected to the rotational member can thus be displaced relative to the pull-out member. As a result, the force acting on the pull-out member along the pull-out direction is also transmitted to the further pull-out member connected to the coupling member. As a result, the further pull-out member is displaced along the pull-out direction relative to the pull-out member. The force acting on the pull-out member along the pull-out direction can be effected by pivoting the lever.

By forming the coupling member with a chain or a band, the minimum extension and the maximum extension of the telescopic device may differ by more than one length of the rotational member along a longitudinal extension axis of the rotational member. In particular, the first distance and the second distance of the center of the at least one connecting portion may differ by more than one length of the rotational member along a longitudinal extension axis of the rotational member.

Basically, the longitudinal extension axis of the rotational member in the closure position of the at least one connecting portion defines a closure axis of the opening device. Furthermore, the longitudinal extension axis of the rotational member in the open position of the at least one connecting portion defines an opening axis of the opening device.

In one embodiment of the proposed opening device, the lever, the telescopic device and the support member can be configured in such a way that the closure axis and the opening axis form an acute opening angle. As a result, the vehicle door can be prevented from resting against the vehicle outer skin with little design effort.

In an alternative embodiment, the lever, the telescopic device and the support member can be configured in such a way that the opening axis and the closure axis are arranged in parallel. In particular, this allows the vehicle door to be displaced completely out of the opening in the vehicle outer skin. This means that the vehicle door does not overlap with the opening in the vehicle outer skin in the open position. The vehicle door can thus be displaceable further along the longitudinal extension axis of the vehicle than in embodiments in which the closure axis and the opening axis enclose an acute opening angle.

Furthermore, the support member can basically be configured in multiple parts. In this case, the lever can be hinged to a first part of the support member by the first end portion and the rotational member can be hinged to a second part of the support member by the end portion.

In a further embodiment of the opening device with multi-part support member, the opening device can comprise an extension mechanism for the second part of the support member. Such an extension mechanism can be connectable to the vehicle as well as to the second part of the support member and can be configured to displace the second part of the support member along an extension direction. In particular, the opening device mounted on the vehicle as intended can be arranged on the vehicle such that the extension direction is oriented transversely to the longitudinal extension axis of the vehicle. Furthermore, the second part of the support member can be displaced parallel to the pivoting of the lever via the extension mechanism. By this exemplary embodiment, opening axis and closure axis can be arranged in parallel. The proposed extension mechanism can be displaced by a motor by means of external force.

For parallel arrangement of the opening axis and the closure axis, the second part of the support member can be configured as a lever. In this case, the second part of the support member can be hinged to the first part of the support member. Consequently, the second part of the support member can be pivotable about a pivotal connection of the second part of the support member to the first part of the support member. As a result, the rotational member can be pivotable about a pivotal connection with the second part of the support member as well as about the pivotal connection of the second part with the first part of the support member.

Furthermore, in a further embodiment of the proposed solution, the opening apparatus can comprise a door-step for providing a step for one or more vehicle users in the open position. Such a door-step can be substantially planar in shape. In particular, such a door-step can be configured to be arranged parallel to a vehicle floor in the intended state of the opening device mounted on a vehicle in such a way that a step surface is provided for entering or exiting a vehicle interior. For this purpose, the door-step can be arranged flush with a floor of the vehicle interior in the open position when the opening device is mounted as intended. Alternatively, in the open position, the mounted door-step can have a smaller spacing relative to a ground floor than the floor of the vehicle interior. This can facilitate entering or exiting the vehicle interior. Furthermore, the door-step can be configured to be arranged in the open position along a vertical line above the opening device mounted on a vehicle as intended. Thus, the door-step can shield the intended mounted opening device, at least in sections, from vertical forces such as weight forces of vehicle users. In addition, the proposed door-step increases user safety by preventing the entrapment of bodies or parts of textiles in parts of the opening device.

In a further embodiment, the door-step can be operatively connected to the extension mechanism in such a way that the door-step can be displaced along an extension direction via the extension mechanism. In this way, the door-step of the opening device mounted on a vehicle as intended can be displaceable via the extension mechanism, in particular between a position of use and a position of non-use. In this case, the door-step can be configured to provide the aforementioned stepping surface or step only in the position of use. Alternatively, the door-step mounted as intended can provide a step or tread both in the use position and in the non-use position, which differ in terms of arrangement relative to the floor of the vehicle interior.

In a supplementary embodiment, the displacement of the door-step and the displacement of the vehicle door can be performed simultaneously.

In further alternative or supplementary embodiments, the lever of the opening device can be curved or angled in such a way that it comprises two parallel portions extending parallel to each other. Alternatively, the lever can be shaped as a gooseneck. In these embodiments, the pivotal connection of the lever to the support member can be arranged on a side of the vehicle outer skin facing a vehicle interior when the opening device is mounted on a vehicle as intended. Thus, the pivotal connection of the lever with the support member can be arranged protected from external influences such as weather. Furthermore, the opening device mounted as intended can be arranged on a vehicle in such a way that the pivotal connection of the lever is arranged outside the opening in the vehicle outer skin. In this way, the pivotal connection of the lever to the support member can be arranged in particular between an interior trim facing the vehicle interior and the vehicle outer skin. Such an arrangement also increases user safety by preventing the entrapment of bodies or parts of textiles in parts of the opening device.

The above mentioned object is furthermore also achieved by door assembly which comprises a vehicle door and one of the aforementioned embodiments of the proposed opening device. In this case, the opening device and the vehicle door are connected to the opening device via the at least one connecting portion.

In a further embodiment, the door assembly comprises a further vehicle door and a further opening device connected to the further vehicle door for displacing the further vehicle door. In principle, the two vehicle doors of the door assembly mounted on a vehicle in accordance with the intended use can be configured to jointly close precisely one opening in the vehicle outer skin. In this case, the opening devices can be arranged relative to one another in such a way that the vehicle door and the further vehicle door are displaced in opposite directions when they are displaced from the closure position to the open position. In the embodiment with two vehicle doors, the door assembly mounted as intended can be suitable for closing and opening larger openings in the vehicle outer skin than door assemblies with exactly one vehicle door. Thus, the door assembly in the embodiment with two vehicle doors is particularly suitable for use in public transport to open and close openings that are large enough to allow a plurality of vehicle users to enter and/or exit the vehicle at the same time.

In a further embodiment, the further opening device can comprise at least one displacement member that is operatively connected to the further vehicle door. A displacement movement of the displacement member can cause the further vehicle door to open or close. By means of an operative connection of the lever of the opening device with the displacement member of the further opening device, the door assembly can be configured to displace the vehicle door and the further vehicle door simultaneously when mounted on a vehicle as intended.

In an alternative or supplementary embodiment, the further opening device can be one of the aforementioned embodiments of the proposed opening device. In particular, the opening device and the further opening device can be of identical configuration and, when mounted on the vehicle as intended, can be arranged on the vehicle in mirror image. In an exemplary embodiment of the door assembly with two identical opening devices, the two rotational members of the opening devices can be connected to each other. In particular, the two connected rotational members can be of integral configuration. Thus, in an embodiment of the door assembly with two identical opening devices, the opening device and the further opening device can have a common rotational member.

In this case, the common rotational member can be hinged to the support member of the opening device and/or the further support member of the further opening device via a thrust joint. This can reduce the number of moveable parts and improve synchronization of the displacement movements of both opening devices. In principle, the support member and the further support member can also be connected to each other.

To reduce the number of drives required, the door assembly in the embodiment with two identical opening devices can be configured to effect pivoting of both levers via precisely one motor by means of external force. For this purpose, the lever of the opening device and the further lever of the further opening device can be operatively connected in such a way that pivoting is transmitted from one of the two levers to the other of the two levers.

Alternatively, to increase redundancy, both opening devices can each comprise an independent drive which is operatively connected to one of the levers. This means that if one of the two vehicle doors fails, the further vehicle door can still be displaced by means of external force. In a further alternative configuration, the two drives of the two opening devices can be operatively connected in such a way that both vehicle doors can be displaced via each of the two drives.

The embodiments described above for the opening apparatus apply analogously to the door assembly.

Furthermore, the problem mentioned at the beginning is also solved by a vehicle having one of the aforementioned embodiments of the door assembly.

In this context, the embodiments described above for the door assembly also apply analogously to a proposed vehicle.

### BRIEF DESCRIPTION OF THE DRAWINGS

The attached figures illustrate possible exemplary embodiments of the proposed solution.

FIG. 1A shows a schematic plan view of a first embodiment of an opening device comprising a support member, a telescopic device having a connecting portion in a closure position, and a lever.

FIG. 1B shows a schematic plan view of the opening device of FIG. 1A in a further position.

FIG. 1C shows a schematic plan view of the opening device of FIG. 1A in an open position of the connecting portion.

FIG. 2A shows a perspective view of a second embodiment of the opening device in the open position with a curved lever and a further pull-out member.

FIG. 2B shows a perspective view of the opening device of FIG. 2A in a further position.

FIG. 2C shows a perspective view of the opening device of FIG. 2A in the open position.

FIG. 3A shows a perspective view of two opening devices with a common rotational member and a door-step.

FIG. 3B shows a perspective view of the opening devices of FIG. 3A in another from a further perspective.

FIG. 3C shows a perspective view of the opening devices of FIG. 3B in a further position.

FIG. 4A shows a perspective view of a first embodiment of a door assembly having an opening device and a vehicle door in the closure position.

FIG. 4B shows a perspective view of the door assembly of FIG. 4A in a further position.

FIG. 4C shows a perspective view of the door assembly of FIG. 4A in the open position.

FIG. 5 a shows detailed perspective view of a curved lever with motorized drive.

FIG. 6A shows a perspective view of a vehicle with a door assembly in the closure position with two opening devices but without illustration of the second vehicle door.

FIG. 6B shows a perspective view of the vehicle of FIG. 6A with the door assembly in a further position.

FIG. 6C shows a perspective view of the vehicle of FIG. 6A with the door assembly in the open position.

FIG. 7 shows a perspective view of a second embodiment of a vehicle having a door assembly in the open position with two door assemblies.

### DETAILED DESCRIPTION

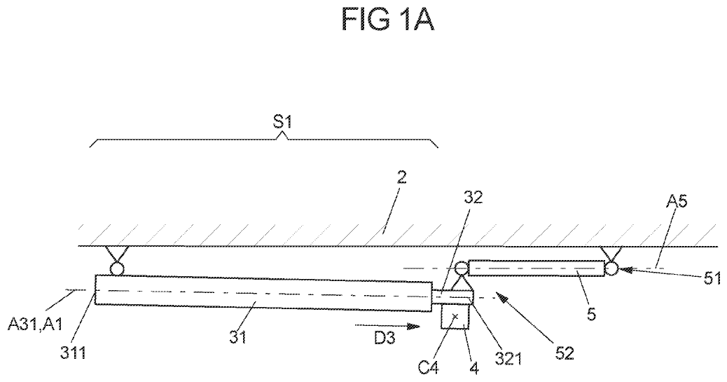

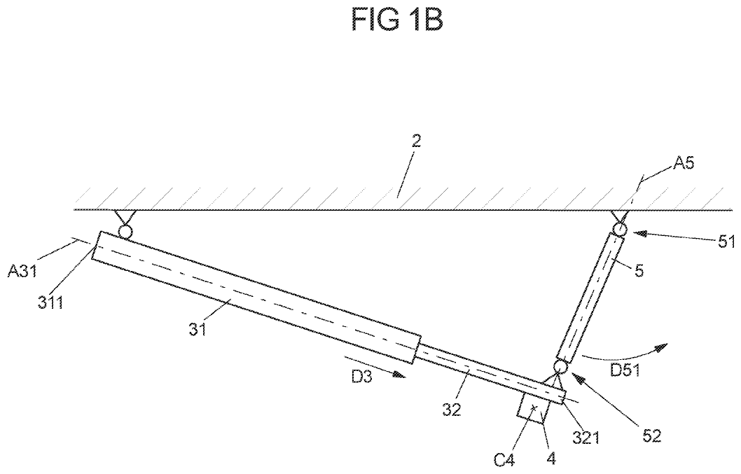

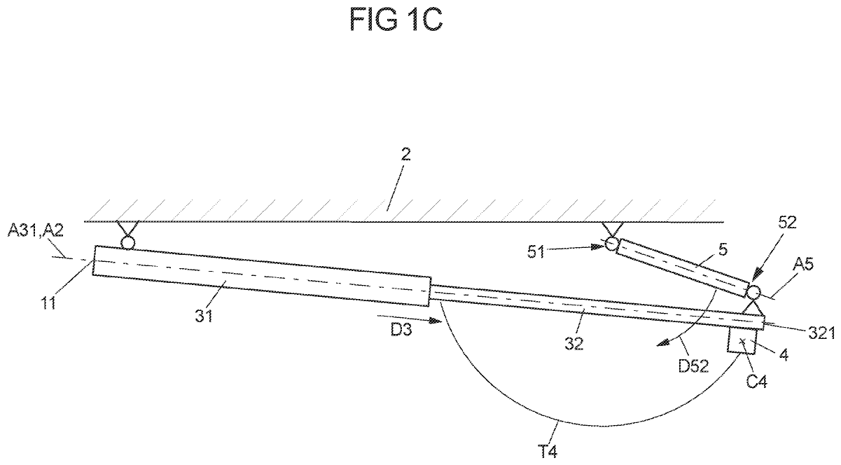

FIG. 1A shows a schematic plan view of a first embodiment of an opening device according to the proposed solution. Such an opening device comprises, inter alia, a support member 2 which is adapted to be attached to a vehicle 1. Furthermore, the opening device comprises a telescopic device 3, which in turn comprises a rotational member 31 and at least one pull-out member 32. Here, the rotational member 31 is hinged to the support member 2 by an end portion 311 and the at least one pull-out member 32 is mounted on the rotational member 31 so as to be translationally displaceable along a pull-out direction D3 relative to the rotational member 31. At least one connecting portion 4 is arranged on the at least one pull-out member 32 for connecting the telescopic device 3 to a vehicle door 11 of the vehicle 1. Furthermore, the proposed opening device comprises a lever 5 which is rotatably hinged to the support member 2 by a first end portion 51 and rotatably hinged to the at least one pull-out member 32 by a second end portion 52 in order to displace the vehicle door 11 connected to the telescopic device 3 by pivoting the lever 5.

By pivoting the lever 5, a displacement movement of the vehicle door 11 connected to the telescopic device 3 is effected with at least two differently directed movement components. Via a pivotal connection of the rotational member 31 with the support member 2, the vehicle door 11 is displaced with a first movement component. By means of sliding the at least one pull-out member 32 along the pull-out direction D3, the vehicle door 11 is displaced with a second movement component. Thus, the opening device is basically configured to lift the vehicle door 11 out of an opening in a vehicle outer skin via the first movement component by pivoting the lever 5 and to displace it relative to the opening via the second movement component in order to release the opening for use.

Here, the embodiment shown in FIG. 1A comprises exactly one pull-out member 32. In principle, however, the number of pull-out members 32 is not limited. Furthermore, in the embodiment shown, the rotational member 31, the pull-out member 32 and the lever 5 are each formed as rods. In particular, the rotational member 31 is configured as a hollow rod, which comprises a cylindrical cavity in which the pull-out member 32 is slidably mounted. The pull-out member 32 is accommodated by the cavity of the rotational member 31 except for an end portion 321 facing away from the rotational member 31. The connecting portion 4 is arranged at the end portion 321 of the pull-out member 32. The connecting portion 4 is shown in a closure position. In this position, a center point C4 of the connecting portion 4 has a first distance S1 relative to the end portion 311 of the rotational member 31. Furthermore, the telescopic device 3 has a minimum longitudinal extension in the direction of the longitudinal extension axis A31 of the rotational member 31.

Due to the mounting of the pull-out member 32 in the cavity of the rotational member 31, a longitudinal extension axis A31 of the rotational member 31 is oriented parallel with respect to the pull-out direction D3. In addition to the connecting portion 4, the lever 5 is also hinged to the end portion 321 of the first pull-out member 32. In the illustrated position of the opening device, the longitudinal extension axis A31 of the rotational member 31 and a longitudinal extension axis A5 of the lever 5 are oriented substantially parallel to each other. The longitudinal extension axis A31 of the rotational member 31 defines a closure axis A1 in the illustrated closure position.

FIG. 1B shows the embodiment of the opening device of FIG. 1A in a further position of the connecting portion 4. Here the lever 5 is pivoted along an opening direction D51 compared to the position shown in FIG. 1A. Due to a pivotal connection of the lever 5 with the pull-out member 32, the pull-out member 32 is displaced along the pull-out direction D3 relative to the rotational member 31. The longitudinal extension axes A31, A5 enclose a right angle in the further position shown. In particular, the longitudinal extension axes A31, A5 are not arranged parallel. As a result, the connecting portion 4 arranged on the pull-out member 32 is also displaced with respect to both the support member 2 and the end portion 311 with respect to the closure position. In an analogous description, the connecting portion 4 is displaced with respect to the closure position along an X-axis and a Y-axis of a coordinate system shown.

By further pivoting the lever 5 in the opening direction D51, the further position shown in FIG. 1B changes into the closure position of the connecting portion 4 shown in FIG. 1C. In this case, the pull-out member 32 is displaced along the pull-out direction D3 relative to the rotational member 31 by the pivoting of the lever 5 in the opening direction D51 in such a way that the center point C4 of the connecting portion 4 is at a second distance S2 relative to the end portion 311 of the rotational member 31. Accordingly, the connecting portion 4 is displaced along the X-axis and counter to the Y-axis of the coordinate system shown, with respect to the position shown in FIG. 1B. Thus, the connecting portion 4 is displaced along a displacement path T4 by the displacement movement shown in FIGS. 1A to 1C. In FIG. 1C, the telescopic device 3 is present in a maximum longitudinal extension in the direction of the longitudinal extension axis A31 of the rotational member 31. Here, the orientation of the longitudinal extension axis A31 of the rotational member 31 in the open position defines an opening axis A2. The closure axis A1, which is not shown in FIG. 1C, forms an acute angle with the opening axis A2. In principle, the telescopic device 3 can be moved back to the minimum extension by pivoting the lever 5 in a closing direction D52, and thus the connecting portion 4 can be displaced to the closure position.

As a result of the connection of the telescopic device 3 to the vehicle door 11, the vehicle door 11 can also be displaced along the displacement path T4 of the connecting portion 4 by the pivoting movement of the lever 5. Depending on the pivotal direction D51, D52 of the lever 5, displacement from the open position to the closure position is also possible. Consequently, the opening device mounted on a vehicle as intended is configured to displace the vehicle door 11 along the displacement path T4 from the closure position to the open position by pivoting the lever 5 in the opening direction D51. In addition, the opening device mounted as intended is configured to displace the vehicle door 11 along the displacement path T4 from the open position to the closure position by pivoting the lever 5 in the closing direction D52. In particular, the opening device can be arranged on the vehicle 1 in such a way that the vehicle door 11 connected to the opening device closes an opening in the vehicle outer skin in the closure position. In the open position, the vehicle door 11 can be flush with the vehicle outer skin.

According to a curvature of the displacement path T4, the displacement movement of the vehicle door 11 has at least two differently directed movement components. In a first movement component, the vehicle door 11 is pivoted about the connection of the rotational member 31 to the support member 2. In a second movement component, the vehicle door 11 is displaced along the pull-out direction D3. In an analogous description, this also corresponds to a superposition of a movement with an X-component and a Y-component.

In an alternative embodiment of the opening device shown in FIGS. 1A to 1C, the rotational member 31 and/or the pull-out member 32 can be formed in a structure that differs from rods. In particular, the pull-out member 32 can be slidably mounted on the rotational member 31 via a rail guide. By using a rail guide, friction can thereby be reduced when the pull-out member 32 is displaced relative to the torque 31. Furthermore, both the rotational member 31 and the pull-out member 32 as well as the lever 5 can be stiffened against applied forces by suitable profiling.

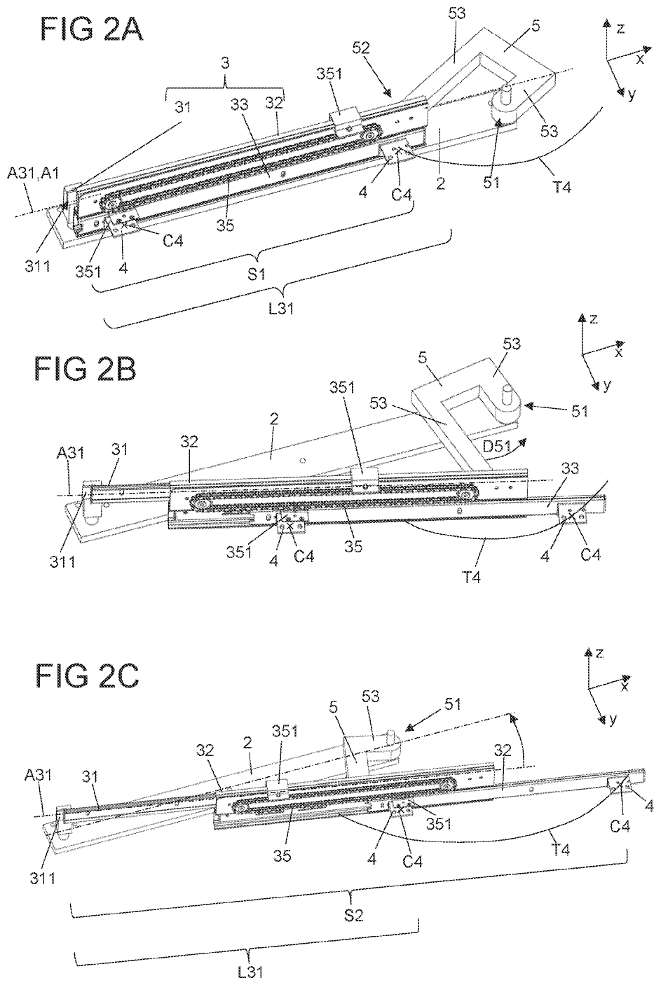

FIG. 2A shows a perspective view of a second embodiment of the opening device with a curved lever 5. The curved lever 5 is substantially U-shaped and comprises two parallel portions 53. The two end portions 51, 52 of the lever 5 are each part of one of the parallel portions 53. Furthermore, the embodiment in FIG. 2A, in contrast with the embodiment in FIGS. 1A to 1C, comprises a further pull-out member 33. In this case, the further pull-out member 33 is mounted on the pull-out member 32 such that it can be displaced along the pull-out direction D3 relative to the pull-out member 32. The further pull-out member 33 is pivotable about the pivotal connection of the rotational member 31 to the support member 2. The further pull-out member 33 is displaceable along the pull-out direction D3 via a bearing on the pull-out member 32 relative to the pivoting movement of the further pull-out member 32. By pivoting the lever 5, the pull-out member 32 can be displaced relative to the rotational member 31 and the further pull-out member 33 can be displaced relative to the pull-out member 32 along the pull-out direction D3. The rotational member 31, the pull-out member 32 and the further pull-out member 33 are each configured as rails. The pull-out member 32 is guided by the rotational member 31 and the further pull-out member 33 by the pull-out member 32. The pull-out member 32 can be displaced along the pull-out direction D3 relative to the rotational member 31 and the further pull-out member 33 can be displaced along the pull-out direction D3 relative to the pull-out member 32. A coupling member 35 is arranged on the pull-out member 32. This is formed with a chain which runs around the pull-out member 32 via two gears. Here, the chain is oriented in such a way that it has two opposing parallel sections in the direction of a Z axis. At each of the parallel sections of the chain, a coupling link 351 is connected to the chain. In each case one coupling link 351 is connected to the rotational member 31 and one is connected to the further pull-out member 33. Thus, the rotational member 31 and the pull-out members 32,33 are in operative connection via the chain. Accordingly, the telescopic device 3 is configured to transmit a force acting on the pull-out member 32 in the direction of the pull-out direction D3 to the further pull-out member 33. A reversal of direction of the force transmission is also possible. Thus, the telescopic device 3 is also configured to transmit a force acting on the pull-out member 32 counter to the direction of the pull-out direction D3 to the further pull-out member 33. Consequently, the two pull-out members 32, 33 can be displaced in a coupled manner along or counter to the pull-out direction D3 by transmitting a force to the pull-out member 32. In the closure position of the connecting portion 4 shown in FIG. 2A, the rotational member 31, the pull-out member 32 and the further pull-out member 33 are thereby pushed into one another. This means that the rotational member 31 and the two pull-out members 32,33 are substantially congruent in a projection onto a YZ plane. Thus, the telescopic device 3 is in the minimum extension along the longitudinal extension axis A31 of the rotational member 31. The longitudinal extension axis A31 defines the closure axis A1 in the illustrated closure position. Furthermore, the telescopic device 3 comprises two connecting portions 4, which are each arranged on the further pull-out member 33. Both connecting portions 4 are located at the respective first distance S1 with respect to the end portion 311 of the rotational member 31. For reasons of clarity, only the first distance S1 of one of the connecting portions 4 is shown in FIG. 2A. By pivoting the lever 5 along the opening direction D51, each of the connecting portions 4 is displaceable along a respective curved displacement path T4. Here, too, the illustration is limited to the displacement path T4 of one of the connecting portions 4.

In FIG. 2B, the lever 5 is pivoted along the opening direction D51 compared to the illustration in FIG. 2A. Due to an pivotal connection of the lever 5 to the pull-out member 32, which is not shown, the pull-out member 32 is therefore displaced along the pull-out direction D3 by an displacement distance compared to the illustration in FIG. 2A. Accordingly, the circulating chain connected to the rotational member 31 via one of the coupling links 351 is also displaced by the same displacement distance compared to the illustration in FIG. 2A. Furthermore, the further pull-out member 33 connected to the chain via the other of the coupling links 351 is displaced by the same displacement distance compared to the illustration in FIG. 2A. As a consequence, the connecting portions 4 arranged on the further pull-out member 33 are located at a position on the displacement path T4 between the closure position and the open position. Accordingly, the connecting portions 4 are displaced along both an X-axis and a Y-axis of the depicted coordinate system compared to the illustration in FIG. 2A.

By further pivoting the lever 5 in the opening direction D51, the opening device changes from the arrangement shown in FIG. 2B to the arrangement shown in FIG. 2C. Here, the parallel portion 51 of the lever 5 facing the telescopic device rests in sections against the pull-out member 32. Further pivoting of the lever 5 in the opening direction D51 is therefore not possible. Consequently, the telescopic device 3 is present in the maximum extension along the longitudinal extension axis A31 of the rotational member 31. Furthermore, both connecting portions 4 are in the open position, wherein the center points C4 of the connecting portions are arranged in each case at the respective second distance S2 with respect to the end portion 311 of the rotational member 31. For reasons of clarity, only the second distance S2 of one of the two connecting portions 4 is shown. Due to the configuration of the telescopic device 3 with two coupled pull-out members 32, 33, the first distance S1 of FIG. 2A and the second distance S2 of FIG. 2C differ by more than one length of the rotational member L31 along the longitudinal extension axis L31 of the rotational member 31. Here, the longitudinal extension axis A31 defines the opening axis A2. In the embodiment of the opening device illustrated in FIGS. 2A to 2C, the opening axis A2 and the closure axis A1 thereby enclose an opening angle α, where: 0<α<90°. In this case, the displacement along the X axis is predominant in the displacement path T4 of the embodiment shown.

In principle, the lever 5 can be formed in an alternative embodiment deviating from the embodiment shown without parallel portions 53. In particular, the lever 5 can be in the form of a gooseneck. Furthermore, the number of pull-out members is not limited to the two pull-out members 32, 33 shown here. Likewise, the telescopic device 3 can comprise three or more pull-out members, each of which is guided along the pull-out direction D3 in a displaceable manner on the rotational member 31 or one of the further pull-out members. By means of a plurality of coupling members 35, the displacement of a first pull-out member 32 relative to the rotational member 31 can be transferred to all further pull-out members. Thus, embodiments with a plurality of pull-out members can realize a greater amount of displacement of the at least one connecting portion 4 along the X-direction.

In a further alternative embodiment, the coupling member 35 can be formed with a toothed rack. This can be connected to the rotational member 31 for coupling the displacement of the pull-out member 32 with the displacement of the further pull-out member 33, as an example. The toothed rack 34 can be in engagement with a gear rotatably mounted on the further pull-out member 33, which in turn meshes with a toothed rack 34 of the pull-out member 32. Displacement of the pull-out member 32 causes rotation of the gear of the further pull-out member 33, which in turn rolls on the toothing of the pull-out member 32 and thus drives the further pull-out member 33.

In another alternative embodiment, the toothed racks 34 can also be arranged on the rotational member 31 and the further pull-out member 33, respectively. In this case, the rotatable gear can be arranged on the pull-out member 32 in such a way that it is in engagement with the two toothed racks 34.

In addition, the lever 5 can always be operatively connected to a motor for displacement of the opening device by means of external force.

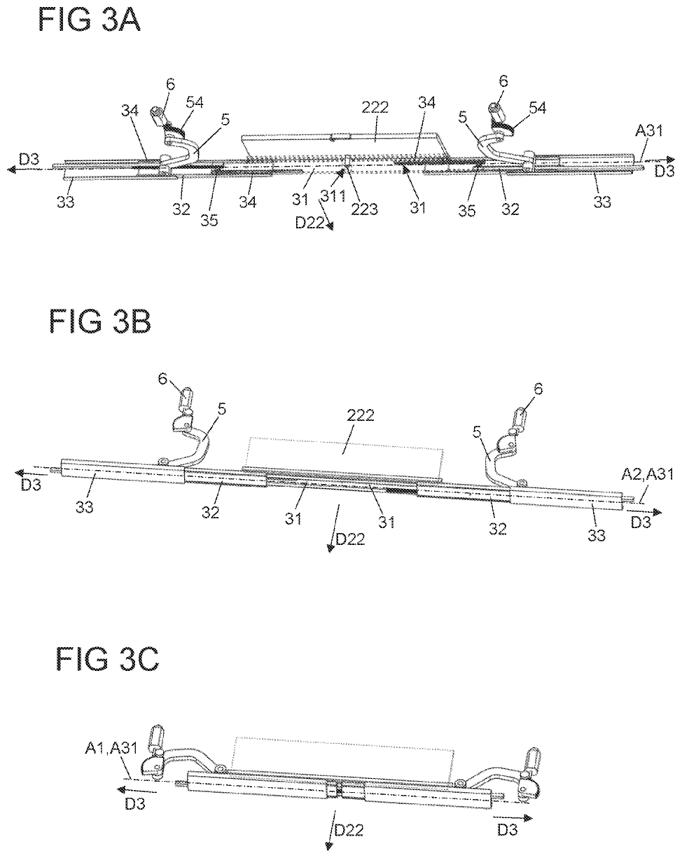

FIG. 3A shows a perspective illustration of two identically configured but differently arranged opening devices. Here, the two rotational members 31 are connected to each other in the region of the end portions 311 and thus represent a common rotational member 31. In this case, the common rotational member 31 is guided along the longitudinal extension axis A31 on a guide pin 223 of a door-step 222. Accordingly, the common rotational member 31 can in principle be displaced relative to the door-step 222 along the longitudinal extension axis L31 of the rotational member 31. Centering of the rotational member 31 in the illustrated open position is effected by limiting the displacement of the rotational member 31 relative to the pull-out members 32 of both opening devices. In the embodiment shown, the limitation is effected by the configuration of a coupling of the common rotational member 31 with one of the pull-out members 32 and the further pull-out members 33 of the opening devices. Here, the coupling member 35 of each of the opening devices is formed with a gear arranged on the respective pull-out member 32. This gear meshes with toothed racks 34 arranged on the common rotational member 31 and the respective second pull-out member 33. The toothed racks 34 each comprise two stops, not shown, for limiting the displacement of the pull-out members 32, 33 relative to the common rotational member 31.

The door-step is mounted on the vehicle 1 so as to be displaceable along an extension direction D22 in a manner not shown in order to implement a thrust joint. Furthermore, both opening devices each comprise a swan-neck-shaped lever 5. The levers 5 are each operatively connected to a respective drive 6 via an operative connection 54. As in the embodiment shown in FIGS. 2A to 2C, the further pull-out members 33 of both opening devices are each mounted on the respective pull-out members 32 so as to be displaceable along the pull-out directions D3 relative to the respective pull-out members 32. The common rotational member 31 is hinged to the support member 2, which is not shown, via the above-mentioned thrust joint. The two pull-out members 32, 33 of one of the opening devices in each case are operatively connected to one another in a manner not shown, whereby a displacement of each of the pull-out members 32 along the pull-out direction D3 leads to a displacement of the respective further pull-out member 33 along the pull-out direction D3. By pivoting the lever 5, the pull-out members 32 can thus be displaced relative to the rotational member 31 and the further pull-out members 33 can be displaced relative to the respective pull-out member 32 along the respective pull-out direction D3.

FIG. 3B shows the opening apparatuses of FIG. 3A in the open position in a further perspective. As in FIG. 3A, the levers 5 are fully displaced in the opening direction D51. In this embodiment, the limitation is represented by the stops of the toothing, which are not shown. These block a further displacement of the pull-out members 32 relative to the rotational member 31 in the direction of the pull-out direction D3. The longitudinal extension axis A31 of the rotational member 31 defines the opening axis A2 in the illustrated open position.

By displacing the lever 5 in the closing direction D52, the opening devices move to the closure position shown in FIG. 3C. In this case, each of the pull-out members 32 is displaced in the opposite direction to the pull-out direction D3 by being connected to a respective one of the levers 5. The coupling members 35, which are not shown, transmit the displacement of the pull-out members 32 to one of the further pull-out members 33 in each case. As a result, the further pull-out members 33 are also each displaced opposite to the pull-out direction D3 of the respective opening device until the closure position is reached. Via the thrust joint connection of the rotational member 31, the rotational member 31 is displaced counter to the extension direction D22. The displacement movement of the rotational member 31 is transmitted to the door-step 222 via the guide pin 223, so that the door-step 222 is also displaced counter to the extension direction D22. The longitudinal extension axis A31 of the rotational member 31 defines the closure axis A1 in the depicted closure position. The closure axis A1 and the opening axis A2 of FIG. 3B are arranged parallel to each other.

In an alternative embodiment, the support member 2 can basically be configured in multiple parts. In this case, the opening device can comprise an extension mechanism for a second part of the support member 2. The second part of the support member 2 can be connected to the vehicle 1 via the extension mechanism and be configured to be displaced transversely to the longitudinal extension axis L1 of the vehicle 1. In particular, the second part of the support member 2 can be displaced simultaneously with the pivoting of the lever 5. By this exemplary embodiment, opening axis A2 and closure axis A1 can be arranged in parallel. In particular, this allows the vehicle door 11 to be lifted out of the open position substantially transversely to the longitudinal extension axis L1 of the vehicle 1.

Furthermore, in another embodiment of the proposed solution, the opening apparatus can comprise a door-step 222 coupled to the second part of the support member 2 such that by displacing the second part via the extension mechanism, the door-step 222 is movable transversely to the longitudinal extension axis L1 of the vehicle 1.

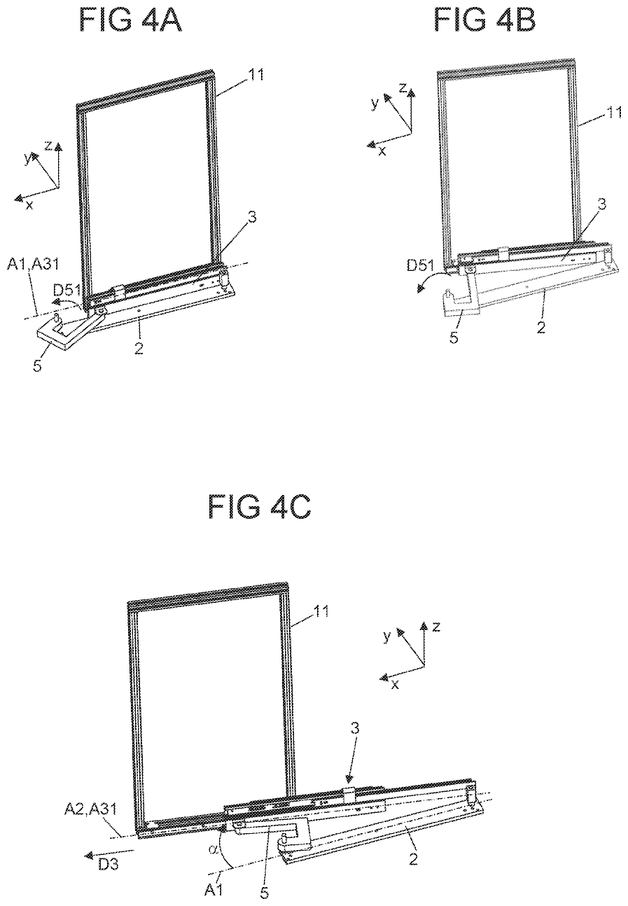

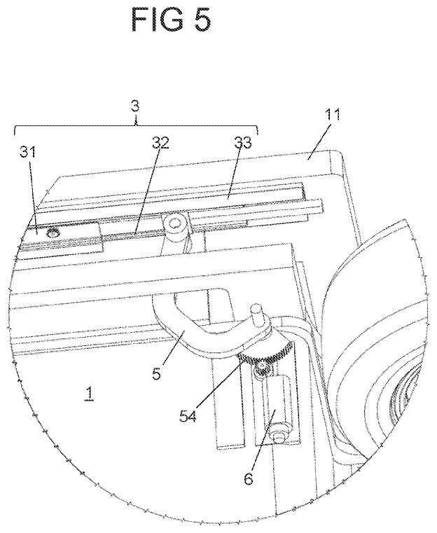

FIG. 4A shows a perspective view of a first embodiment of a door assembly with an opening device and a vehicle door 11 in the closure position. Here, the opening device shown comprises the support member 2, the lever 5 and a telescopic device 3. Analogous to the embodiment shown in FIGS. 2A to 2C, the telescopic device comprises the two pull-out members 32, 33 and the rotational member 31 with the longitudinal extension axis L31, which defines the closure axis A1 in the closure position. Here, the vehicle door 11 is connected to the second pull-out member 33 via the connecting portions 4, which are not shown. By pivoting the lever 5 in the opening direction D51, the door assembly is moved to the position shown in FIG. 4B. Here, the telescopic device 3 is displaced about the pivotal connection of the rotational member 31 in the direction of the Y-axis. Thus, the vehicle door 11 connected to the telescopic device 3 can be lifted out of an opening in a vehicle outer skin. By further pivoting the lever 5 in the opening direction D51, the door assembly moves to the open position shown in FIG. 4C. Here, the pull-out member 32 is displaced along the pull-out direction D3 by the pivotal connection with the lever 5. The coupling member 35, which is not shown, transfers the displacement of the first pull-out member 32 along the pull-out direction D3 to the further pull-out member 33. Thus, compared to the position shown in FIG. 4B, the vehicle door 11 is displaced counter to the direction of the Y-axis and along the direction of the X-axis. In this case, the longitudinal extension axis L31 of the rotational member 31 defines the opening axis A2 in the open position shown. The opening axis A2 and the closure axis A2 thereby enclose the opening angle α. Here, a is an acute angle.

FIG. 5 shows a detailed perspective view of a door assembly arranged on the vehicle 1 with the vehicle door 11, the telescopic device 3 and the lever 5. The lever 5 can be driven by the motor drive 6 via an operative connection 54. The lever 5 and the drive 6 are arranged below a floor of a vehicle interior.

In an alternative embodiment, the drive 6 can further comprise a cover to shield the drive 6 and the operative connection 54 from corrosive influences and dirt.

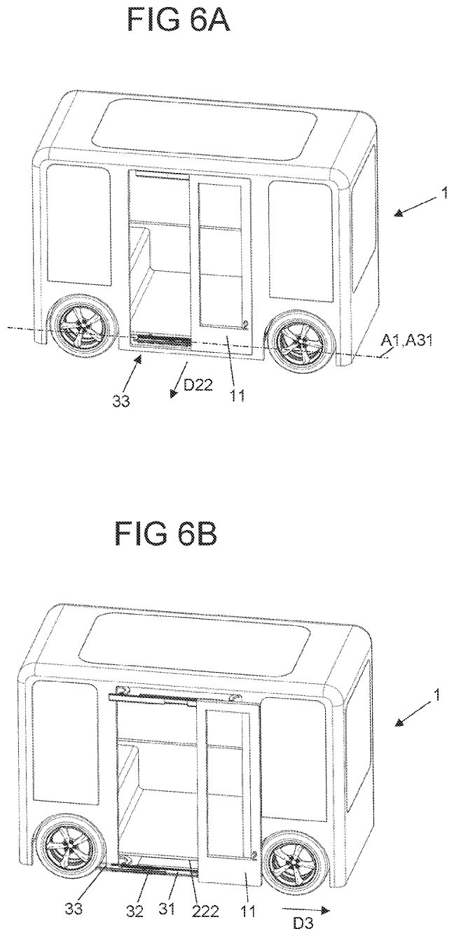

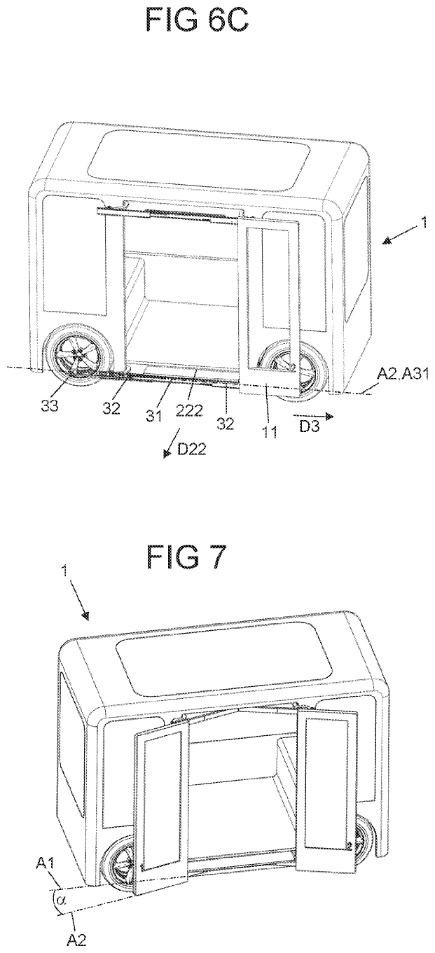

FIG. 6A shows a perspective view of a vehicle 1 with a door assembly in the closure position. Here, the illustration is limited to a vehicle door 11 in order to provide a view of the opening device. However, this is to be seen only as a design feature and not as a feature of the embodiment shown. Here, the vehicle 1 comprises two door assemblies of identical construction but arranged differently. Each of the door assemblies comprises the lever 5, the support member 2 and the telescopic device 3. The telescopic device 3 comprises the rotational member 31, the pull-out member 32 and the further pull-out member 33, wherein in each case one vehicle door 11 is connected to one of the further pull-out members 33. The two rotational members 31 are connected to one another in the region of the end portions 311 and thus constitute a common rotational member 31. The further pull-out members 33 of both opening devices are each mounted on the respective pull-out members 32 so as to be displaceable along the pull-out directions D3 relative to the respective pull-out members 32. By connecting the common rotational member 31 to the support member 2, which is not shown, via a linearly guided door-step 222, the common rotational member 31 is hinged to the support member 2 via a thrust joint. The pull-out members 32, 33 of each of the opening devices are operatively connected to each other in a manner not shown, whereby a displacement of the pull-out member 32 along the pull-out direction D3 relative to the rotational member 31 results in a displacement of the further pull-out member 33 along the pull-out direction D3. Via the pivoting of the lever 5, the pull-out members 32 can thus be displaced relative to the rotational member 31 and the further pull-out members 33 can be displaced relative to the respective pull-out members 32 along the respective pull-out directions D3. The longitudinal extension axis A31 of the rotational member 31 defines the closure axis A1 in the depicted closure position.

By displacing the lever 5 in the opening direction D51, the vehicle doors 11 are each displaced to the position shown in FIG. 6B. In the process, each of the pull-out members 32 is displaced along the pull-out direction D3 by connection with a respective one of the levers 5. The coupling members 35, which are not shown, transmit the displacement of the pull-out members 32 to one of the further pull-out members 33 in each case. As a result, the further pull-out members 33 are also each displaced along the pull-out direction D3 of the respective opening device until the open position is reached. Via the thrust joint connection of the rotational member 31, the rotational member 31 is displaced along the extension direction D22. The displacement movement of the rotational member 31 is transmitted to the door-step 222 via an operative connection of the door-step 222 to the rotational member 31, which is not shown, so that the door-step 222 is also displaced along the extension direction D22.

By further pivoting the lever 5 in the opening direction D51, the vehicle doors are each displaced to the open position shown in FIG. 6C. Due to the configuration of the pivotal connection of the rotational member 32 with the support member 2 as a thrust joint, the longitudinal extension axis L31 is always oriented parallel to the closure axis A1 during the displacement movement. In particular, the opening axis A2 is also oriented parallel to the closure axis A1.

In an alternative embodiment, the rotational members 31 of the two door assemblies can also be unconnected. This means that they can both be separately hinged to the support member 2. In particular, the support member 2 can also have a multi-part design.

The following configuration refers to one of the two door assemblies, but is also applicable to the second.

In a further embodiment, one of the parts of the support member 2 can be formed as a lever. In this case, the part formed as a lever can be hinged to a further part of the support member 2 and the rotational member 31. Consequently, the part formed as a lever can be pivotable about the pivotal connection of the part formed as a lever to the further part of the support member 2.

In an alternative embodiment of the opening device with multi-part support member 2, the opening device can comprise an extension mechanism for the second part of the support member 2. In this case, the second part of the support member 2 can be connected to the vehicle 1 via the extension mechanism. The extension mechanism is in turn configured to displace the second part of the support member transversely to the longitudinal extension axis L1 of the vehicle 1. In particular, the second part of the support member 2 can be displaced parallel to the pivoting of the lever 5. By this exemplary embodiment, opening axis A2 and closure axis A1 can be arranged in parallel.

FIG. 8 shows a further embodiment of the vehicle 1 with an embodiment of the door assembly. In accordance with the embodiment of the door assembly shown in FIGS. 4A to 4C, the closure axis A1 and the opening axis A2 form an acute angle α.

### NEW LIST OF REFERENCE CHARACTERS

1 vehicle
L1 longitudinal extension axis of the vehicle
11 vehicle door
A1 closure axis of the opening device
A2 opening axis of the opening device
α opening angle
2 support member
D22 extension direction
222 door-step
223 guide pin
3 telescopic device
D3 pull-out direction
31 rotational member
A31 longitudinal extension axis of the rotational member
L31 length of the rotational member
311 end portion of the rotational member
32 pull-out member
321 end portion of the first pull-out member
33 further pull-out member
34 toothed rack
35 coupling member
351 coupling link
4 connecting portion
C4 center of the connecting portion
T4 displacement path
S1 first distance
S2 second distance
5 lever
A5 longitudinal extension axis of the lever
51 first end portion
52 second end portion
53 parallel portions
54 operative connection
6 drive

1. An opening device for displacing a vehicle door, comprising:
a support member for fastening the opening device to a vehicle;
a telescopic device, comprising a rotational member which is hinged to the support member by an end portion; and
a pull-out member which is mounted on the rotational member so as to be displaceable along a pull-out direction relative to the rotational member;
at least one connecting portion arranged on the pull-out member for connecting the telescopic device to the vehicle door of the vehicle; as well as
a lever which is rotatably hinged to the support member by a first end portion and to the pull-out member by a second end portion in order to displace the vehicle door connected to the telescopic device by pivoting of the lever.

2. The opening device according to claim 1, wherein the telescopic device comprises a further pull-out member which is mounted on the pull-out member such that it can be displaced along the pull-out direction relative to the pull-out member.

3. The opening device according to claim 2, wherein the at least one connecting portion is arranged on the further pull-out member.

4. The opening device according to claim 2, wherein the rotational member is operatively connected to the pull-out member and the pull-out member is operatively connected to the further pull-out member in each case via a rail guide.

5. The opening device according to claim 2, wherein the rotational member is operatively connected to the further pull-out member via a coupling member in such a way that a displacement of the pull-out member relative to the rotational member along the pull-out direction causes a displacement of the further pull-out member relative to the pull-out member along the pull-out direction.

6. The opening device according to claim 5, wherein the coupling member is formed with a chain or a band and the chain or the band is arranged circumferentially on the pull-out member and is connected respectively to the rotational member and the further pull-out member.

7. The opening device according to claim 1, wherein the at least one connecting portion is displaceable between a closure position and an open position by the pivoting of the lever, and a first distance measured from the end portion of the rotational member to a center of the connecting portion in the closure position and a second distance measured from the end portion of the rotational member and the center of the connecting portion in the open position differ by more than a length of the rotational member along a longitudinal extension axis of the rotational member.

8. The opening device according to claim 7, wherein
the longitudinal extension axis of the rotational member defines a closure axis of the opening device at the closure position of the at least one connecting portion, and an opening axis of the opening device in the open position of the at least one connecting portion, wherein closure axis and opening axis form an acute opening angle, or
the longitudinal extension axis of the rotational member defines a closure axis of the opening device in the closure position of the at least one connecting portion, and an opening axis of the opening device in the open position of the at least one connecting portion, wherein closure axis and opening axis are oriented parallel to one another.

9. (canceled)

10. The opening device according to claim 1, wherein the support member is configured in multiple parts, wherein the lever is hinged to a first part of the support member by the first end portion and the rotational member is hinged to a second part of the support member by the end portion.

11. The opening device according to claim 10, wherein the second part of the support member is configured as a lever, which is hinged to the first part of the support member.

12. The opening device according to claim 10, wherein the second part of the support member is connected to the vehicle by means of an extension mechanism in such a way that the second part can be displaced along an extension direction transverse to a longitudinal extension axis of the vehicle.

13. The opening device according to claim 12, wherein the second part is coupled to a door-step in such a way that by displacing the second part via the extension mechanism, the door-step can be displaced transversely to the longitudinal extension axis of the vehicle.

14. (canceled)

15. The opening device according to claim 1, wherein the lever is curved or angled in such a way that it comprises two parallel portions extending parallel to one another.

16. The opening device according to claim 1, wherein the lever can be pivoted by means of external force.

17. A door assembly, comprising a vehicle door and an opening device according to claim 1 for displacing the vehicle door, wherein the vehicle door is connected to the opening device via the at least one connecting portion.

18. The door assembly according to claim 17, wherein the door assembly comprises a further vehicle door and a further opening device connected to the further vehicle door for displacing the further vehicle door.

19. The door assembly according to claim 18, wherein the further opening device comprises at least one displacement member which is operatively connected to the further vehicle door, and a displacement movement of the displacement member causes the further vehicle door to be opened or closed, and the displacement member is operatively connected to the lever of the opening device for the simultaneous displacement of the vehicle door and the further vehicle door.

20. The door assembly according to claim 18, wherein the further opening device includes:
a further support member for fastening the further opening device to the vehicle;
a further telescopic device;
at least one further connecting portion arranged on the further pull-out member for connecting the further telescopic device to the vehicle door of the vehicle; as well as
a further lever which is rotatably hinged to the further support member by a further first end portion by a further second end portion in order to displace the vehicle door connected to the further telescopic device by pivoting of the further lever.

21. The door assembly according to claim 20, wherein the opening device and the further opening device comprise a common rotational member.

22. A vehicle, comprising a door assembly according to claim 17.
